(19) United States
(12) Patent Application Publication
(10) Pub. No.: US 2022/0268424 A1
(43) Pub. Date: Aug. 25, 2022

(54) LIGHT SOURCE HAVING A VARIABLE ASYMMETRIC BEAM

(71) Applicant: LENSVECTOR INC., San Jose, CA (US)

(72) Inventor: Tigran GALSTIAN, Québec (CA)

(21) Appl. No.: 17/632,825

(22) PCT Filed: Aug. 7, 2020
(86) PCT No.: PCT/CA2020/051086

§ 371 Date: Feb. 4, 2022

Related U.S. Application Data
(60) Provisional application No. 62/883,795, filed on Aug. 7, 2019.

(51) Int. Cl. F21V 13/02; F21V 7/05; F21V 14/00

(52) U.S. Cl. CPC F21V 13/02; F21V 7/05; F21V 14/003

(57) ABSTRACT

An architectural lighting device for wall washing providing suitable beam modulation is described herein. The device combines a variable divergence beam source (a light source along with a beam stretching element) in combination with a specially designed side reflector that redirects a portion of a broadened beam back onto the wall so as to have wall illumination increase with beam divergence.

### CROSS-REFERENCE TO RELATED APPLICATIONS

This application claims priority from U.S. Provisional Patent Application 62/883,795 filed Aug. 7, 2019, the contents of which are hereby incorporated by reference.

### TECHNICAL FIELD

The present application relates to controllable light sources, for example to controllable spot beam light sources that are used in architectural lighting.

### BACKGROUND

Lighting plays an important role in architecture. For example, the arrangement of angularly narrow (or so-called spot) beams plays an important role in how a space is perceived by people. The brightness and the divergence angle of spot beam light sources, along with their locations, are carefully selected to provide the desired lighting effect.

In some cases, spot beams must be arranged to have an asymmetrical beam shape, for example when placed near a wall or partition and the light beam is to illuminate the floor along with the adjacent wall or partition. This is called “wall washing” and has important applications, e.g., in architectural lighting.

Arranging spot beam light sources to project light with a suitable beam profile for wall washing is a difficult challenge given that the needs for the beam the shape depend on the desired visual effect, the distance between the fixture and the wall, the source beam shape, etc. This requires a careful design and use of expensive professional work force to install and adjust the light source. This, in turn, generates the necessity to be able to dynamically change the beam direction.

### SUMMARY

Applicant has developed beam shaping and directing liquid crystal devices as described in PCT published application WO2017/041167 on Mar. 16, 2017 and in PCT published application WO2016/082031 on Jun. 2, 2016, both designating the US, the specifications of which are hereby incorporated by reference. Such devices can be electrically controlled to dynamically and remotely change the shape of a light source beam. In most cases, one wants the device to modulate the beam symmetrically, however, the devices disclosed can in some cases modulate a beam along one axis, thus providing an asymmetric beam modulation (or stretching dominantly in one plane).

Applicant has discovered that in the case of wall washing, existing devices fail to provide a suitable beam modulation since in many cases the amount of wall illumination is to be variable. This requires a beam modulation that is not found in existing devices.

Applicant proposes herein a solution that combines a variable divergence beam source (a light source along with an asymmetric beam stretching element) in combination with a specially designed side reflector that redirects a portion of a broadened beam (diverted away in the opposite direction from an adjacent wall) back onto the wall so as to have wall illumination increase with beam divergence.

When the light source is broadened only in one axis, namely the direction perpendicular to the wall, the spot light source can be thus only modulated to vary the amount of wall illumination with the spot beam keeping its shape along a direction of the wall. This may be desirable in some case, however, broadening in the direction along the wall may be suitable in other cases. Applicant's beam broadening devices can in some cases provide selective control over broadening in one direction and in the other.

Applicant has also found that a non-linear shaped mirror or reflector can be used to ensure that variable control over the source beam divergence can provide a corresponding control over the height of the beam on the wall. Finally, applicant found that the use of scattering reflectors can smoothen the shape of light distribution on the wall.

A first broad aspect is a narrow-angle light beam modulator including a controllable light beam broadening device controllable between a narrow beam and a broader beam state for broadening a light beam in at least one axis, and a side reflector arranged to redirect a portion of the light beam broadened to one side to be redirected in an opposite direction.

In some embodiments, the controllable light beam broadening device includes a liquid crystal beam broadening device controllable to broaden the light beam in one plane.

In some embodiments, the controllable light beam broadening device includes a liquid crystal beam broadening device controllable to broaden the light beam in two perpendicular planes.

In some embodiments, the side reflector includes at least one diffusing reflector.

In some embodiments, the side reflector includes a number of planar reflector segments.

In some embodiments, the side reflector includes a single curved reflector surface.

In some embodiments, the side reflector includes a diffuser or scattering reflector.

In some embodiments, the side reflector can be electrically variable.

In some embodiments, a wall washing light source includes a circular spot beam light source and a spot light beam modulator.

In some embodiments, a wall washing light source includes a linear or rectangular beam of light source and a light beam modulator.

In some embodiments, a combined wall and floor illumination system includes a light source and a light beam modulator.

### BRIEF DESCRIPTION OF THE DRAWINGS

The invention will be better understood by way of the following detailed description of embodiments of the invention with reference to the appended drawings, in which:

FIG. 1A is an illustration of a narrow spot beam directed to a floor at a foot of a wall or partition.

FIG. 1B is an illustration of wider spot beam than in FIG. 1A that is directed to illuminate a same portion of the floor and a lower portion of the wall.

FIG. 1C is an illustration of a wide spot beam that is directed to illuminate a same portion of the floor as in FIG. 1B and most of the wall.

FIG. 2 is a schematic illustration of a dynamic beam broadening device modulating a source beam with a reflector acting on one side of the beam.

FIGS. 3A to 3C are a schematic illustration of a different embodiment in which broadening of the beam does not substantially increase floor illumination, in which FIG. 3A shows a narrow beam, FIG. 3B a wider beam and FIG. 3C a widest beam with increasing amounts of wall illumination.

FIGS. 4A and 4B compare the difference in wall illumination between a linear reflector/diffuser and a non-linear or segmented reflector/diffuser, in which FIG. 4A shows the linear reflector and FIG. 4B the non-linear reflector.

FIG. 5A shows a simulation of a beam projection using a segmented reflector, in which sharp transitions in the beam intensity can be observed.

FIG. 5B shows a simulation of a beam projection using a toroidal reflector, in which less abrupt transitions in the beam intensity can be observed.

FIGS. 6A through 6D show an embodiment similar to FIG. 2 in four states of operation, namely in FIG. 6A a narrow spot beam that does not illuminate the wall, FIG. 6B a broader spot beam illuminating essentially only the floor without reflection, FIG. 6C a broader spot beam illuminating the lower portion of the wall, and FIG. 6D a wide spot beam illuminating floor below and most of the wall.

### DETAILED DESCRIPTION

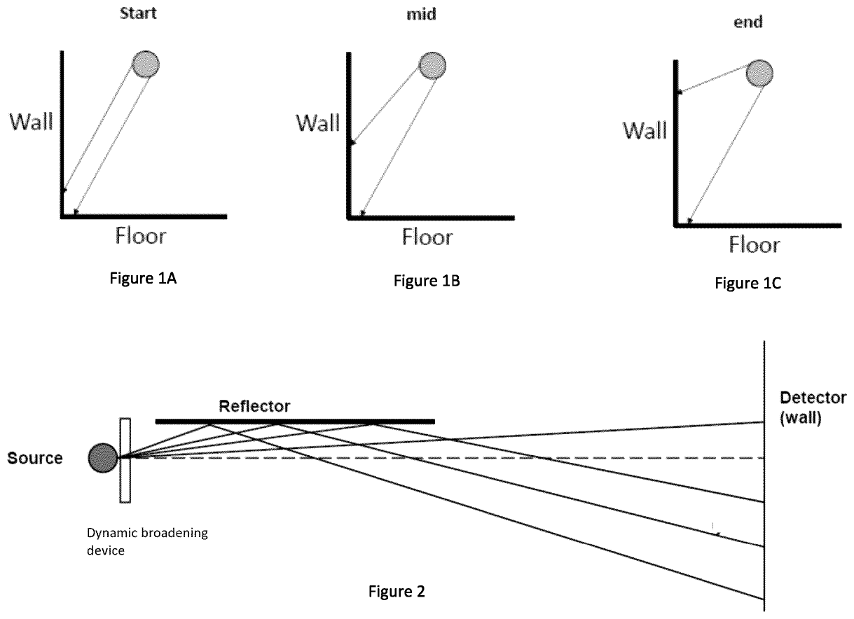

As shown in FIGS. 1A to 1C, in many cases, it is desired also to illuminate different portions of space in a specific order, for example, it can be a wall or a biological object (vertically growing plant), and the need will be to illuminate only one part of it, then, with time, illuminate also another portion, etc. As will be appreciated, the optimized installation of such “wall-washing” lighting is very complicated and must be done in a custom manner, since the parameters of the light source and its position (and orientation) are critical.

In FIG. 2, it is proposed to use a combination of an external reflector along with a dynamic broadening device (either symmetric or, preferably, asymmetric) to obtain such an asymmetric illumination system that can be adjusted as needed. The dynamic broadening device can be a liquid crystal device. This will greatly simplify the installation and optimization of such systems. The original light source and the emitted original light may be of circularly symmetric or linear or rectangular form. The liquid crystal device and the reflector may be designed to match that form. The reflector can be long and flat as illustrated (it may further be an assembly of multiple smaller reflectors and may also be curved in addition to planar) and it can be a diffusion reflector or specular.

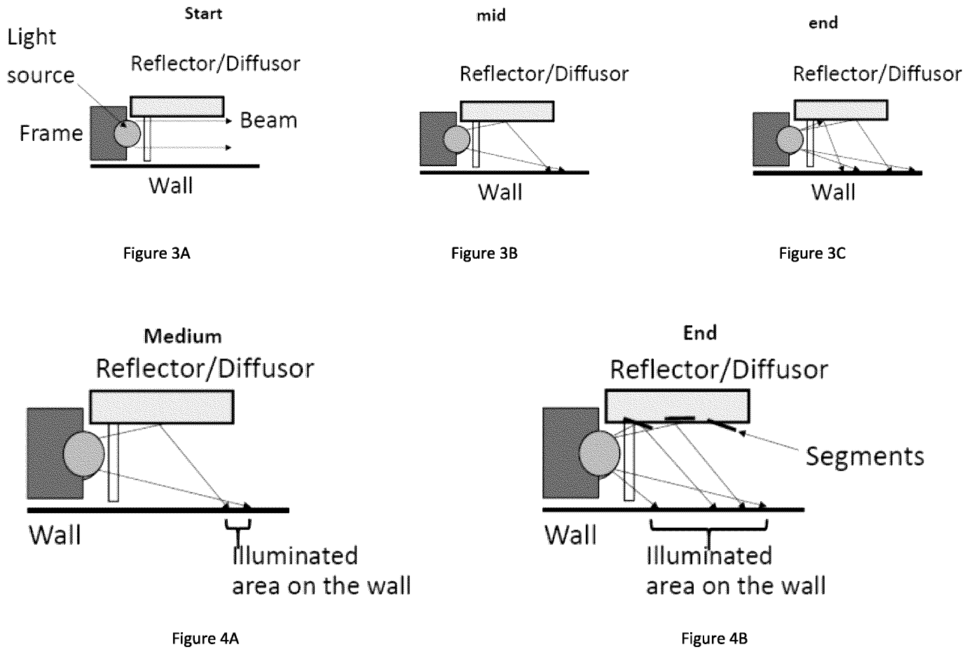

As shown in FIGS. 3A to 3C, a combination of an external reflector/diffusor along with one of the above-mentioned dynamic broadening devices (either symmetric or, preferably, asymmetric) to obtain such an asymmetric illumination system. The reflecting surface of the Reflector/Diffusor can be designed to provide a desired wall illumination as a function of beam broadening by the liquid crystal device. For example, if the desire is to dynamically extend and specially accentuate the illumination to a specific form, then the reflecting surface may be nonlinearly curved consequently.

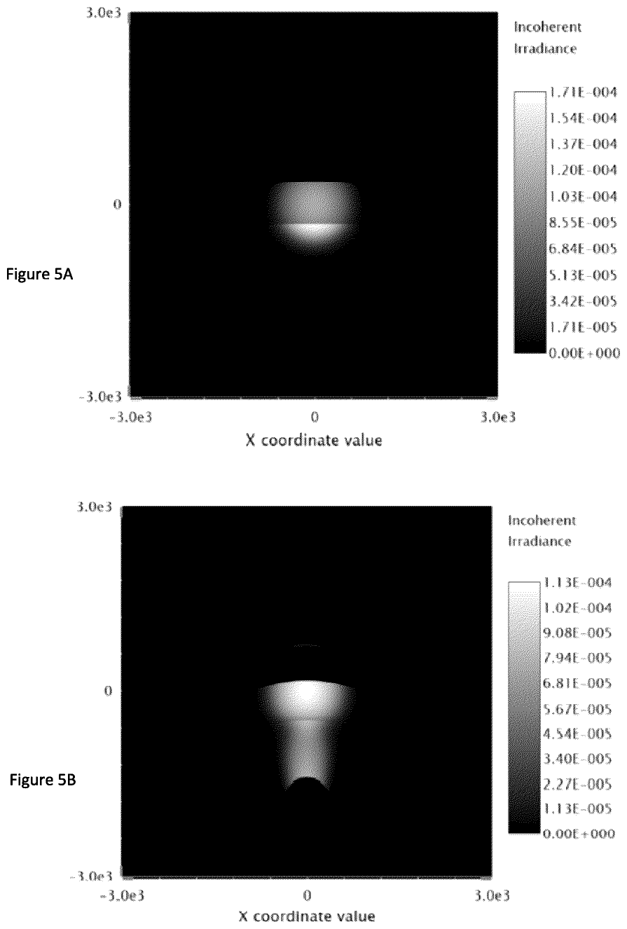

To illustrate the above-mentioned, reference is made to FIGS. 4A and 4B that show differences in dynamically extending the illuminated area on the wall. In FIG. 4B, various areas (or segments) of the reflector may be oriented at various directions in 3D space to optimize the final illumination pattern. In some cases, it may be preferable to use the asymmetric broadening device here. However, the combination of two or more broadening devices can also be considered: symmetric and asymmetric broadening, for example, to be used simultaneously at different levels.

In another embodiment, the reflector or diffuser segments themselves can be variable broadening (electrically controllable reflecting or scattering) devices, as it is known in the art (see PCT patent application publication WO2015/103709 dated Jul. 16, 2015 designating the US, the specification of which is hereby incorporated by reference). As it is shown in the simulation of FIG. 5A, the use of simple reflectors can generate sharp transition zones in the intensity of light (direct and redirected light). To resolve this problem, still in another embodiment, the segments can be covered by stationary diffusors to smoothen the light distribution pattern (to avoid sharp corners created by individual segments of the reflector).

In another embodiment the reflector is a continuous toroidal or other non-linearly shaped reflector. FIG. 5B illustrate a simulated spot beam created by a 10 cm by 12 cm toroidal reflector tilted by 5 degrees.

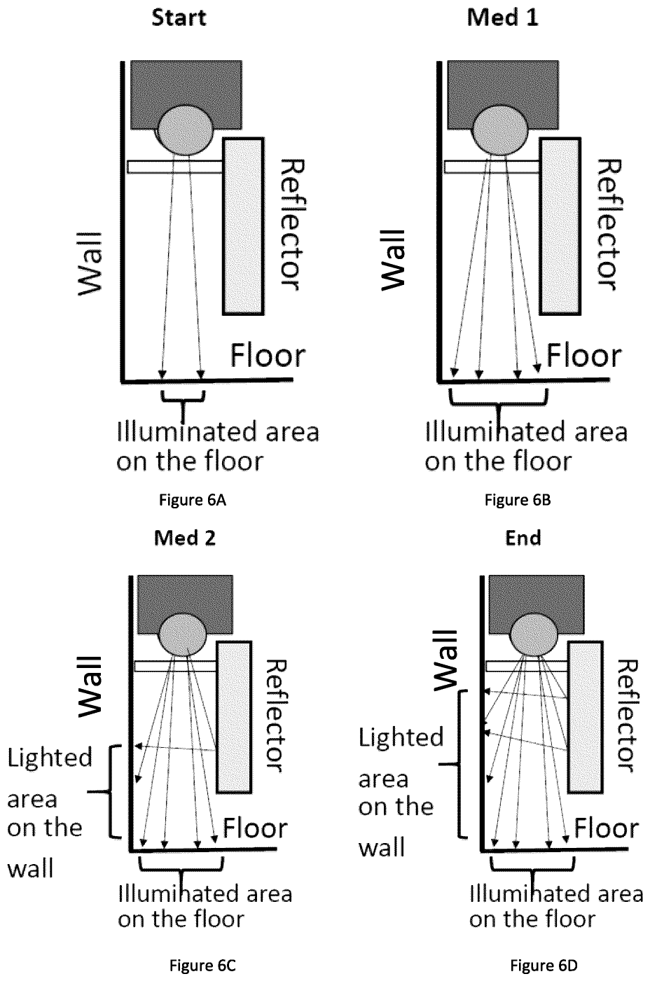

Still in another embodiment, the reflector/diffuser can be designed in a way, to allow some degree of light beam broadening in the original direction of lighting to perform simple “spot-to-flood” illumination, as illustrated in FIGS. 6A through 6D. In this case, with the further broadening of light, the reflector/diffuser starts contributing and redirecting light on the wall. Similar performance can be achieved if we first broaden light symmetrically up to a predetermined angular divergence (or spot size) and then start stretching (asymmetrically broadening) light to variably illuminate mainly the wall.

1. A narrow-angle light beam modulator comprising a controllable light beam broadening device controllable between a narrow beam and a broader beam state for broadening a light beam in at least one axis, and a side reflector arranged to redirect a portion of said light beam broadened to one side to be redirected in an opposite direction.

2. The modulator as defined in claim 1, wherein said controllable light beam broadening device comprises a liquid crystal beam broadening device controllable to broaden said light beam in one plane.

3. The modulator as defined in claim 1, wherein said controllable light beam broadening device comprises a liquid crystal beam broadening device controllable to broaden said light beam in two perpendicular planes.

4. The modulator as defined in claim 1, wherein said side reflector comprises at least one diffusing reflector.

5. The modulator as defined in claim 1, wherein said side reflector comprises a number of planar reflector segments.

6. The modulator as defined in claim 1, wherein said side reflector comprises a single curved reflector surface.

7. The modulator as defined in claim 1, wherein said side reflector comprises a diffuser or scattering reflector.

8. The modulator as defined in claim 1, wherein said side reflector is electrically variable.

9. A wall washing light source comprising a circular spot beam light source and a spot light beam modulator as defined in claim 1.

10. A wall washing light source comprising a linear or rectangular beam of light source and a light beam modulator as defined in claim 1.

11. A combined wall and floor illumination system comprising a light source and a light beam modulator as defined in claim 1.
